(19) United States
(12) Patent Application Publication
(10) Pub. No.: US 2006/0067006 A1
(43) Pub. Date: Mar. 30, 2006

(54) Magnetic head and magnetic recording and reproducing apparatus

(75) Inventors: Masayuki Takagishi, Kunitachi-shi (JP); Kotaro Yamamoto, Tachikawa-shi (JP); Tomoko Taguchi, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/235,084

(22) Filed: Sep. 27, 2005

(30) Foreign Application Priority Data
Sep. 30, 2004 (JP) 2004-286539

(51) Int. Cl. G11B 5/127; G11B 5/33

(52) U.S. Cl. 360/319

(57) ABSTRACT

A magnetic head includes a read head including a read element and two layers of shields sandwiching the read element therebetween, and a write head including a main pole, a return yoke, and an exciting coil, in which at least one of each of the shields and the return yoke has an area of a bottom surface at least 1.2 times as large as an area of a top surface.

### CROSS-REFERENCE TO RELATED APPLICATIONS

This application is based upon and claims the benefit of priority from prior Japanese Patent Application No. 2004-286539, filed Sep. 30, 2004, the entire contents of which are incorporated herein by reference.

### BACKGROUND OF THE INVENTION

1. Field of the Invention

The present invention relates to a magnetic head and a magnetic recording and reproducing apparatus.

2. Description of the Related Art

Magnetic heads presently used in hard disk drives (HDDs) have a read head including a read element such as a giant magnetoresistive (GMR) element and two layers of shields sandwiching the read element therebetween, and a write head including a main pole, a return yoke, and an exciting coil. Some other known structures have an additional shield for the write head. Of these members, for example, the main pole is often processed to have a complicated shape in order to improve write efficiency. However, no particular considerations are given to the shape of the shields or the return yoke, so that the shield and the return yoke are processed into rectangular because of ease of manufacturing.

However, if an external stray field exists, a magnetic thin film such as the shield acts like an antenna to collect fluxes. The fluxes may disadvantageously erase magnetic signals recorded on a media. In particular, if the media includes a soft underlayer as in the case of a perpendicular recording system, a flux circuit is formed in the media, thus making the above problem more marked.

To solve this problem, a known magnetic head employs a structure in which an end surface of the shield is recessed from the air-bearing surface of the main pole to hinder fluxes from flowing from the shield to the soft underlayer (see Jpn. Pat. Appln. KOKAI Publication No. 2003-45008).

However, in a magnetic head having such a structure, an increase in the recession amount of the shields degrades the shielding effect, which significantly affects resistance to an external magnetic field. This makes the tolerance for the shield end position very severe, leading to a manufacturing problem.

### BRIEF SUMMARY OF THE INVENTION

A magnetic head according to an aspect of the present invention comprises: a read head including a read element and two layers of shields sandwiching the read element therebetween; and a write head including a main pole, a return yoke, and an exciting coil, wherein at least one of each of the shields and the return yoke has an area of a bottom surface at least 1.2 times as large as an area of a top surface.

A magnetic recording and reproducing apparatus according to another aspect of the present invention comprises the above magnetic head and a perpendicular magnetic recording media having a soft underlayer and a perpendicular magnetic recording layer formed on a nonmagnetic substrate.

### BRIEF DESCRIPTION OF THE SEVERAL VIEWS OF THE DRAWING

FIG. 1 is a cross-sectional view sectioned along a track of a magnetic recording and reproducing apparatus according to an embodiment of the present invention;

FIG. 2 is a diagram illustrating the principle of the present invention;

FIG. 3 is a perspective view of a shield included in a magnetic head according to Example 1 of the present invention;

FIG. 4 is a diagram showing the relationship between the ratio of the (bottom surface width/top surface width) of the shield included in the magnetic head according to the present invention and the resistance to an external magnetic field;

FIG. 5 is a front view of a shield included in a magnetic head according to Example 2 of the present invention;

FIG. 6 is a front view of a shield included in a magnetic head according to Example 3 of the present invention;

FIG. 7 is a front view of a shield included in a magnetic head according to Example 4 of the present invention;

FIG. 8 is a perspective view of a shield included in a magnetic head according to Example 5 of the present invention; and

FIG. 9 is a cross-sectional view sectioned along a track of a magnetic recording and reproducing apparatus according to another embodiment of the present invention.

### DETAILED DESCRIPTION OF THE INVENTION

Embodiments of the present invention will be described below with reference to the drawings.

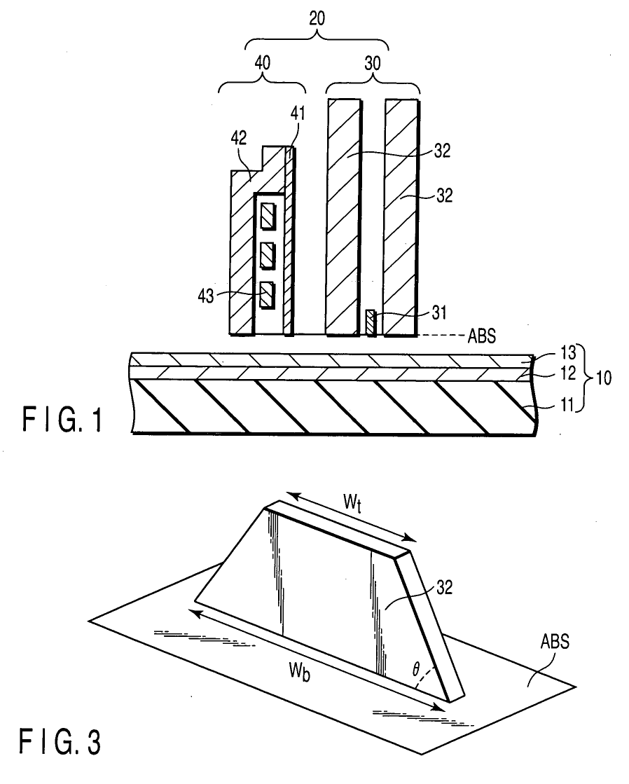

FIG. 1 is a cross-sectional view sectioned along a track of a magnetic recording and reproducing apparatus according to an embodiment of the present invention. As shown in FIG. 1, the magnetic recording and reproducing apparatus has a perpendicular magnetic recording media 10 and a magnetic head 20 positioned above the perpendicular magnetic recording media 10. The perpendicular magnetic recording media 10 has a soft underlayer 12 and a perpendicular magnetic recording layer 13 formed on a nonmagnetic substrate 11. An additional underlayer may be provided between the nonmagnetic layer 11 and the soft underlayer 12, and an intermediate layer may be provided between the soft underlayer 12 and the perpendicular magnetic recording layer 13. In general, a protective layer is formed on the perpendicular magnetic recording layer 13, and a lubricant is applied to the protective layer. The magnetic head 20 includes a read head 30 and a write head 40. The read head 30 includes a read element 31 consisting of a giant magnetoresistive (GMR) element and two layers of shields 32, 32 sandwiching the read element 31 therebetween. The write head 40 includes a main pole 41, a return yoke 42 magnetically coupled to the main pole 41, and an exciting coil 43 that excites the main pole 41. The shields 32 are not recessed from the air bearing surface of the main pole 41.

In the magnetic head according to the embodiment of the present invention, at least one of each shield 32 and the return yoke 42 has an area of the bottom surface at least 1.2 times as large as an area of the top surface. A magnetic head meeting such a condition has improved resistance to an external magnetic field. Both each shield 32 and the return yoke 42 preferably meet this condition. In the description below, the structure and effect of the shield will be representatively described, but similar description is also applied to the return yoke.

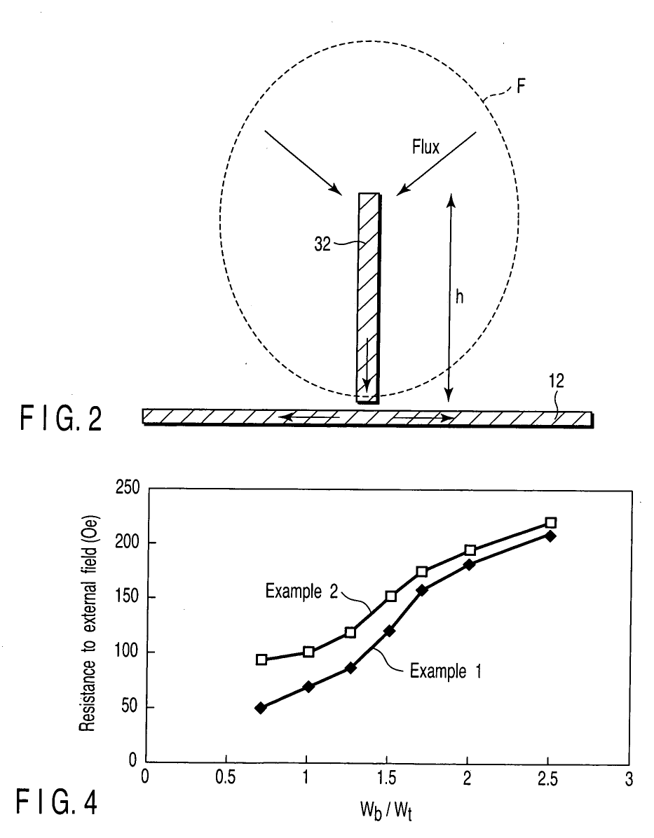

With reference to FIG. 2, the effect of the magnetic head having a shield the bottom surface area of which is at least 1.2 times as large as the top surface area will be described. FIG. 2 shows the soft underlayer 12 included in the perpendicular magnetic recording media, and the shield 32 positioned above the soft underlayer 12. The height of the shield 32 is denoted as h. A dashed line around the shield 32 shows a spherical region F in which fluxes flowing into the shield 32 are present.

The volume of the region F in FIG. 2 is related to the surface area of the shield 32. The ability of the shield 32 to collect fluxes is higher as the distance from the soft underlayer 12 of the media increases, and thus the top surface of the shield 32 is a portion that exerts a most profound effect. The fluxes flowing from the region F into the shield 32 flow from the bottom surface of the shield 32 to the soft underlayer 12. Accordingly, the average field in the bottom surface of the shield 32 is inversely proportional to the bottom surface area of the shield 32. That is, the relationship described below is established:
(average field in bottom surface of shield)∝(volume of region F)/(bottom surface area of shield).
The volume of the region F is substantially related to the entire surface area of the shield. Accordingly, it is conceivable that the resistance to an external field may be increased by reducing the height or width of the shield. However, since the reduction of the width of a conventional shield having a rectangular shape also reduces the bottom surface area, this measure cannot be effective. It is possible to reduce the shield height, which is not related to the bottom surface area. However, the reduction of the shield height is also limited in view of the shielding effect.

In regard to this, the inventors noted that the volume of the region F, contained in the above relation, is correlated with the top surface area of the shield. The inventors then found that the resistance to external field can be improved by reducing the ratio of (top surface area of shield)/(bottom surface area of shield). The inventors have thus completed the present invention. That is, by reducing the top surface area of the shield relative to the bottom surface area of the shield, it is possible to decrease the fluxes flowing from the region F into the shield. It is also possible to decrease the fluxes flowing from the bottom surface of the shield to the soft underlayer. As described below in further detail, the inventors have found that the resistance to external field can be significantly improved by setting the bottom surface area of the shield at least 1.2 times as large as the top surface area.

Various shapes may be possible for the shield or the return yoke the bottom surface area of which is at least 1.2 times as large as the top surface area.

FIG. 3 shows a perspective view of the shield 32 included in a magnetic head according to Example 1 of the present invention. In the shield 32 shown in FIG. 3, the width W_{b} of the bottom surface (the width of the air-bearing surface ABS extending along the track width) is set at least 1.2 times as large as the width Wₜ of the top surface by which the bottom surface area is made at least 1.2 times as large as the top surface area.

FIG. 4 shows the relationship between the ratio of the bottom surface width to the top surface width of the shield according to Example 1 and the resistance to external field (the intensity of the external field at which magnetic signals recorded in the media start to be erased). As shown in FIG. 4, the resistance to external field is improved as the ratio of the bottom surface width to the top surface width increases. Once the ratio of the bottom surface width to the top surface width reaches about 1.2, the resistance to external field appears to be rapidly improved. This is expected to be due to saturation of the soft underlayer in the media. When the soft underlayer in the media is saturated, the field in the bottom surface of the shield is concentrated markedly at the edge of the shield exceeding the average field in the bottom surface of the shield, which degrades the resistance to external field. However, when the ratio of the bottom surface width to the top surface width is made at least 1.2, the saturation of the soft underlayer is expected to be relaxed to improve the resistance to external field. The ratio of the bottom surface width to the top surface width is preferably at least 1.5 and is more preferably at least 2.0 if the resistance to external field must be about 200 Oe.

The ratio of the bottom surface width to the top surface width of at least 1.2 corresponds to 20 μm or more in terms of a difference between the bottom surface width and the top surface width, assuming that the bottom surface width is 60 μm. Moreover, the difference between the bottom surface width and the top surface width is more preferably 30 μm or more.

Further, the ratio of the bottom surface width to the top surface width of at least 1.2 corresponds to 60° or less in terms of the angle θ between the bottom surface and side surface of the shield.

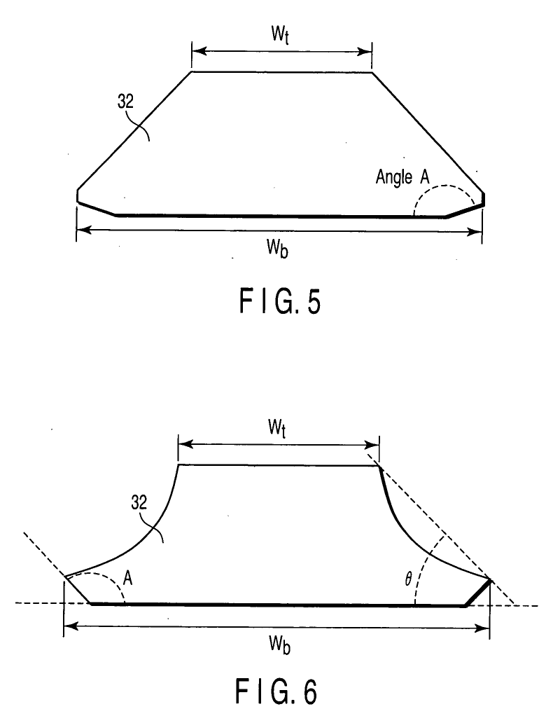

FIG. 5 shows a front view of the shield 32 included in a magnetic head according to Example 2 of the present invention. The shield has an edge surface formed by partly removing the vicinity of edge of the bottom surface. As described above, more fluxes concentrate at the edge of the shied exceeding the average field in the bottom surface of the shield, which may become a factor degrading the resistance to external field. Accordingly, the factor degrading the resistance to an external field can be eliminated by partly removing the vicinity of the edge. In this case, the length W_{b} of the bottom surface of the shield means the maximum length of a line formed by projecting the portions facing the media including the edge surface on the media. The average field in the bottom surface of the shield is determined by a surface obtained by projecting, on the media, the portions of the shield facing the media including the edge surface. On the other hand, a decrease in the angle between the bottom surface and the edge surface reduces the length of the air-bearing surface in a narrow sense, which may hinder the flow of fluxes from the shield to the soft underlayer. However, if the angle A between the bottom surface and the edge surface is an obtuse angle of 160° or more, the flow of fluxes from the shield to the soft underlayer is not hindered.

FIG. 4, already described, also shows the relationship between the ratio of the bottom surface width to top surface width of the shield according to Example 2 and the resistance to external field (the intensity of the external field at which magnetic signals recorded in the media start to be erased). As shown in FIG. 4, degradation of resistance to external field can be avoided in Example 2 by partly removing the vicinity of the edge. Consequently, Example 2 is improved in the resistance to external field compared to Example 1.

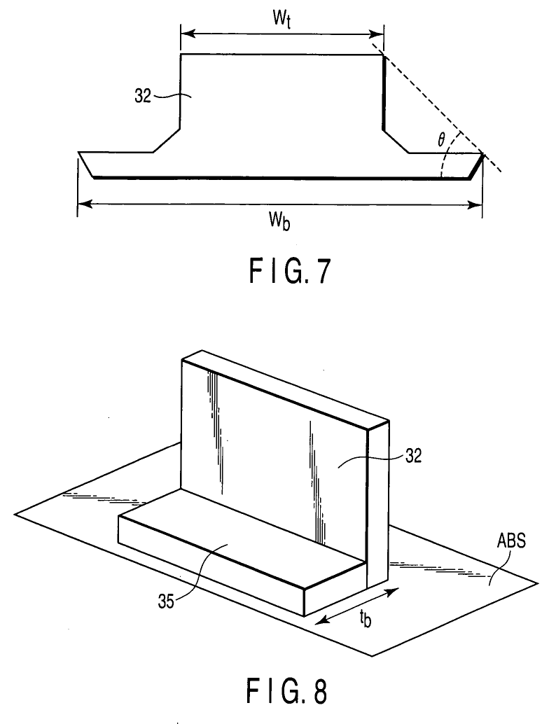

FIG. 6 shows a front view of the shield 32 included in a magnetic head according to Example 3 of the present invention. The side surface of the shield is removed so that the side surface is concave with respect to a ridge line joining the end of the bottom surface with the end of the top surface. As is understood from the above discussion, since fluxes flow in through the side surface of the shield, the fluxes flowing into the shield can be reduced by partly removing the side surface of the shield as shown in FIG. 6. It is also possible to reduce the fluxes flowing from the bottom surface of the shield to the soft underlayer of the media. In this case, the length W_{b} of the bottom surface of the shield as well as the angle A between the bottom surface and the edge surface are as defined in FIG. 5. The angle between the bottom surface and the side surface means the angle between the bottom surface and the ridge line joining vertexes of the side surface together.

FIG. 7 shows a front view of the shield 32 included in a magnetic head according to Example 4 of the present invention. A removed part of side surface of the shield is larger than that shown in FIG. 6.

FIG. 8 shows a perspective view of the shield 32 included in a magnetic head according to Example 5 of the present invention. The thickness t_{b} of the bottom surface of the shield is set at least 1.2 times as large as the thickness of the top surface by which the bottom surface area is made at least 1.2 times as large as the top surface area. Specifically, a protruded part 35 is provided at the top or/and the bottom of the main body of the shield 32. In this case, the shield main body 32 may be rectangular. A gap may be present between the shield main body 32 and the protruded part 35 provided that they are magnetically coupled together. Thus, the shield main body 32 and the protruded part 35 need not physically contact each other.

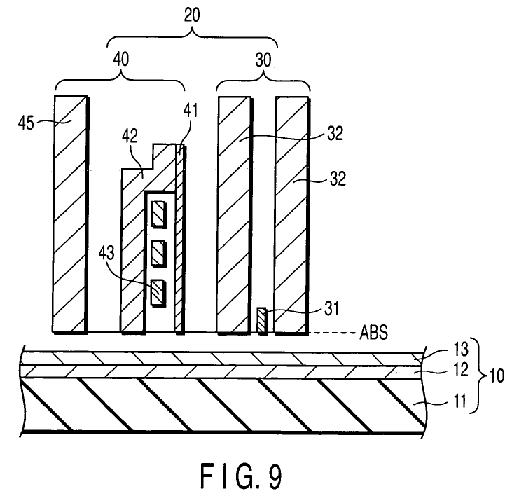

FIG. 9 is a cross-sectional view sectioned along a track of a magnetic recording and reproducing apparatus according to another embodiment of the present invention. This magnetic recording and reproducing apparatus has a write head shield 45 in addition to the configuration shown in FIG. 1. The write head shield 45 preferably meets the condition that the bottom surface area is at least 1.2 times as large as the top surface area.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic head comprising:
a read head including a read element and two layers of shields sandwiching the read element therebetween; and
a write head including a main pole, a return yoke, and an exciting coil,
wherein at least one of each of the shields and the return yoke has an area of a bottom surface at least 1.2 times as large as an area of a top surface.

2. The magnetic head according to claim 1, wherein at least one of each of the shields and the return yoke has a width of the bottom surface at least 1.2 times as large as a width of the top surface.

3. The magnetic head according to claim 2, wherein at least one of each of the shields and the return yoke has a difference between the width of the bottom surface width and the width of the top surface of 20 μm or more.

4. The magnetic head according to claim 1, wherein at least one of each of the shields and the return yoke has an angle between the bottom surface and a side surface of 60° or less.

5. The magnetic head according to claim 1, wherein a vicinity of an edge of the bottom surface of at least one of each of the shields and the return yoke is partly removed to form an edge surface, and wherein an angle between the bottom surface and the edge surface is 160° or more.

6. The magnetic head according to claim 1, wherein the side surface of at least one of each of the shields and the return yoke is processed to be concave with respect to a ridge line joining an end of the bottom surface with an end of the top surface.

7. The magnetic head according to claim 1, wherein at least one of each of the shields and the return yoke has a thickness of the bottom surface at least 1.2 times as large as a thickness of the top surface.

8. The magnetic head according to claim 1, further comprising a write head shield, wherein write head shield has an area of a bottom surface at least 1.2 times as large as an area of a top surface.

9. A magnetic recording and reproducing apparatus comprising:
a magnetic head comprising a read head including a read element and two layers of shields sandwiching the read element therebetween, and a write head including a main pole, a return yoke, and an exciting coil, wherein at least one of each of the shields and the return yoke has an area of a bottom surface at least 1.2 times as large as an area of a top surface; and
a perpendicular magnetic recording media having a soft underlayer and a perpendicular magnetic recording layer formed on a nonmagnetic substrate.

10. The apparatus according to claim 9, wherein at least one of each of the shields and the return yoke has a width of the bottom surface at least 1.2 times as large as a width of the top surface.

11. The apparatus according to claim 10, wherein at least one of each of the shields and the return yoke has a difference between the width of the bottom surface width and the width of the top surface of 20 μm or more.

12. The apparatus according to claim 9, wherein at least one of each of the shields and the return yoke has an angle between the bottom surface and a side surface of 60° or less.

13. The apparatus according to claim 9, wherein a vicinity of an edge of the bottom surface of at least one of each of the shields and the return yoke is partly removed to form an edge surface, and wherein an angle between the bottom surface and the edge surface is 160° or more.

14. The apparatus according to claim 9, wherein the side surface of at least one of each of the shields and the return yoke is processed to be concave with respect to a ridge line joining an end of the bottom surface with an end of the top surface.

15. The apparatus according to claim 9, wherein at least one of each of the shields and the return yoke has a thickness of the bottom surface at least 1.2 times as large as a thickness of the top surface.

16. The apparatus according to claim 9, further comprising a write head shield, wherein write head shield has an area of a bottom surface at least 1.2 times as large as an area of a top surface.
